(19) United States
(12) Patent Application Publication
(10) Pub. No.: US 2015/0021287 A1
(43) Pub. Date: Jan. 22, 2015

(54) GRAPPLE CARRIAGE FOR LOGGING

(71) Applicants: Gary Lee Jones, Napier (NZ); Steven Allen Palmer, Napier (NZ)

(72) Inventors: Gary Lee Jones, Napier (NZ); Steven Allen Palmer, Napier (NZ)

(21) Appl. No.: 14/332,309

(22) Filed: Jul. 15, 2014

Related U.S. Application Data
(60) Provisional application No. 61/846,921, filed on Jul. 16, 2013.

(51) Int. Cl. A01G 23/00; B66C 21/00; B66C 13/18; B66C 1/42; B66C 1/44

(52) U.S. Cl. CPC A01G 23/003; B66C 1/427; B66C 1/447; B66C 13/18; B66C 21/00
USPC 212/84; 212/285

(57) ABSTRACT

A grapple carriage for logging having at least two articulated arms, each arm comprising a vertical movement actuator to control vertical movement of the arm, and a horizontal movement actuator to control horizontal movement of the arm.

### CROSS REFERENCE

This application claims priority to U.S. Provisional Patent Application Ser. No. 61/846,921, entitled “GRAPPLE CARRIAGE FOR LOGGING,” filed Jul. 16, 2013, which is hereby incorporated herein by reference, in its entirety and for all purposes.

### TECHNICAL FIELD

The invention relates to a carriage for use in logging. In particular, the invention relates to a remote controlled logging carriage for transporting one or more logs where the carriage has at least two grapple arms.

### BACKGROUND OF THE INVENTION

Grapple carriages have been in use in logging for decades for moving logs from one location to another. In their simplest form, a grapple is suspended from a line, typically a crane line, and is lowered to the site of a log. The grapple is then manipulated manually to grasp and hold the log, and the log is hoisted vertically and moved to a different location where the log is lowered (for example, to the ground or to a truck) and the grapple then released from the log.

In the continuous drive for increased efficiencies in logging practices, manual operations have been supplanted by remote control automation so that, where possible, the entire operation of grapples, and the movement and function of grapple carriages, is controlled remotely. Most grapple carriages are therefore motorised and the operation of the motors are controlled remotely. One example of a remote-controlled grapple is described in U.S. Pat. No. 3,647,255.

In most logging operations, grapple carriages are suspended from a skyline. A skyline will usually be set up to run from a location were trees are felled to a yarder at a central location (e.g. near a road) from where the logs may be loaded onto transport means (e.g. trucks). Skylines are generally steel cables running around a drive pulley at the central delivery end (e.g. on a yarder) and a return pulley at the collection end. There are several commonly employed logging systems. However, not all require a skyline. The “shotgun” system uses a skyline along which a grapple carriage travels and a “skid line” running from a yarder to the carriage. The skid line is used to drag the carrier and logs back to the yarder. The “slack line” system is the same as the shotgun system but uses a “haul back” which is a line running from the yarder to one or more sheaves/pulleys at or near to the collection area and to the carriage. The function of the haul back is to drag the carriage along the skyline away from the yarder to the collection area. A “running skyline” (also known as a “rider block”) uses no skyline at all, but a skid line in combination with a haul back.

Examples of skyline carriages can be seen in U.S. Pat. No. 4,754,886, U.S. Pat. No. 4,515,281, U.S. Pat. No. 4,454,951 and WO 2012/164464. However, these and other known grapple carriages have limitations. They accommodate only one grapple, they are often cumbersome and are difficult to control, and usually can only retrieve logs that are positioned directly below the skyline.

The complexity of grapples operated via radio signal actuated multiple hydraulic motors means that skyline grapple carriages have only one grapple. Some grapples may be large enough to grasp only a single log whereas other larger grapples may grasp several logs together, but a single grapple remains a significant limitation on the speed and efficiency by which a felled section of logs can be cleared.

In one existing grapple carriage (described in U.S. Pat. No. 5,653,350), a grapple is connected to the carriage by an arm or boom. This provides reach to the grapple so that a log a short distance from, but not directly below, the skyline may be collected. The carriage allows 360° rotation of the arm and grapple. However, although the arm may extend telescopically to give further reach, and the angle from which the arm extends from the carriage can be varied, the arm is a straight rigid arm and, consequently, the grapple is cumbersome and difficult to position over a log or group of logs to be collected unless the arm is kept short. Further, the arm requires a counterweight, which works well when the skyline is level, but not when the skyline is sloping. Skylines often sag in the middle and so have sloping sections (both downward and upward sloping sections). Grapple carriages designed to rotate therefore do not rotate easily on sloping sections because of the effect of the counterweight. In addition, the carriage has to be braked (held stationary) before the grapple is slewed (rotated to orientate the grapple with a log) and with tension on the haul back connected to the counterweight it can be very difficult to rotate the carriage 360°.

As part of ongoing attempts to increase the efficiency of logging operations, leading to significant cost savings, the applicant has found a way to efficiently collect logs from a greater distance from a skyline or other similar lines (e.g. haul back and skid lines).

It is therefore an object of the invention to provide a grapple carriage for logging that goes at least some way towards overcoming the disadvantages of existing grapple carriages, or at least provides a useful alternative to existing grapple carriages.

### SUMMARY OF THE INVENTION

In a first aspect of the invention there is provided a grapple carriage grapple carriage for attaching to a cable suspended above ground and for picking up one or more logs and moving the one or more logs along the path of the cable, the carriage comprising:
a body having a coupler for coupling the body to the cable and enabling the carriage to move along the cable; and
at least two articulated arms extending from the body, each arm having a distal end to which is attached a grapple adapted to pick up, hold and release the one or more logs.

In some forms of the invention, each arm comprises a vertical movement actuator to control vertical movement of the arm, and a horizontal movement actuator to control horizontal movement of the arm.

The coupler may comprise one or more grooved wheels adapted to movably engage with the cable. Each wheel may be rotatably attached to a pair of shivs that are adapted to suspend the grapple carriage from the cable.

Each arm may be pivotably connected to the body via a boom extending from the body, and each may be formed from a plurality of arm segments (for example, 2, 3 or 4 segments) rotatably connected in series. The segments are preferably connected by ball joints, but may alternatively be connected by any other form of rotating joint.

In some forms of the invention, the vertical and horizontal movement actuators of each arm are located at or near the end of that arm and proximal to the body. The vertical and horizontal movement actuators each preferably include an hydraulic ram.

The distal end of each arm may comprise a grapple actuating means for opening and closing jaws of the grapple, and the grapple actuating means may comprise an hydraulic ram.

In Preferred forms of the invention, the grapple carriage comprises a control system to enable the carriage to be controlled remotely. The control system may comprise one or more signal transmitters and receivers. Movement of each arm and each grapple is preferably controlled by hydraulic rams powered by electric motors.

Preferably, each arm is able to extend from the body at a distance of approximately 4 metres.

In a second aspect of the invention there is provided the use of the grapple carriage of the invention for picking up one or more logs and moving the one or more logs along the path of a cable suspended above ground.

In another aspect of the invention there is provided a grapple carriage for picking up one or more logs and moving the one or more logs along the path of a cable suspended above ground, the carriage comprising:

a body having a coupler for coupling the body to the cable and enabling the carriage to move along the cable; and

at least two arms extending from the body, each arm having a distal end to which is attached a grapple adapted to pick up, hold and release the one or more logs.

As used in this specification, the word ‘comprising’, and related words, such as ‘comprise’, ‘comprises’, and ‘comprised’ are intended to mean ‘including, but not limited to’. Therefore, when interpreting statements in this specification that include the term ‘comprising’, other features besides the features prefaced by this term in each statement can also be present.

### BRIEF DESCRIPTION OF THE FIGURES

FIG. 1 is a side view of a grapple carriage according to the invention.

FIG. 2 is a plan view of the grapple carriage of FIG. 1.

FIG. 3 is a side view of the grapple carriage of FIG. 1 showing the arms in different positions.

FIG. 4A is a side view of a grapple to be used with a grapple carriage according to the invention.

FIG. 4B is a cross-sectional view along lines A-A of the grapple of FIG. 4A.

FIG. 5A is a side view of a grapple to be used with a grapple carriage according to the invention.

FIG. 5B is a cross-sectional view along lines B-B of the grapple of FIG. 5A.

FIG. 5C is a perspective view of the grapple of FIG. 5A.

FIG. 6 is a perspective view of the grapple carriage of FIG. 1, in which the booms have been removed.

### DETAILED DESCRIPTION

The Invention broadly relates to a grapple carriage for use in hauling logs along the path of a cable suspended above ground. Such cables are usually referred to as skyline cables, although the carriage of the invention is also applicable to logging systems that do not use a skyline, for example a running skyline. The carriage is attached to a haul line for hauling the carriage along the cable. The carriage comprises two or more arms, each arm being attached to a grapple for holding logs between jaws of the grapple. The grapple carriage may be controlled remotely, and comprises a control system and a plurality of actuators for controlling movement of the arms and the jaws of the grapples. A key advantage of the grapple carriage of the invention is that it is lightweight in comparison to existing grapple carriages that are heavy and therefore require the use of a skyline. Another key advantage is that the grapples have a long reach either side of the path of the cable. This is possible because the carriage has at least one arm either side of the carriage.

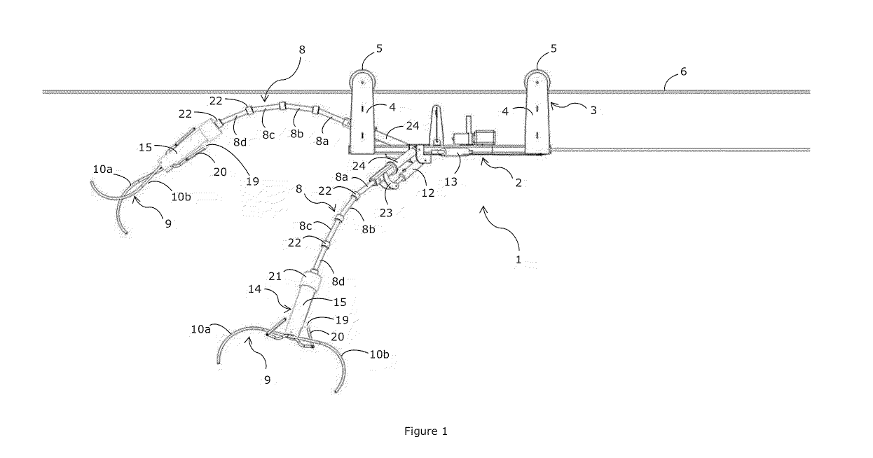

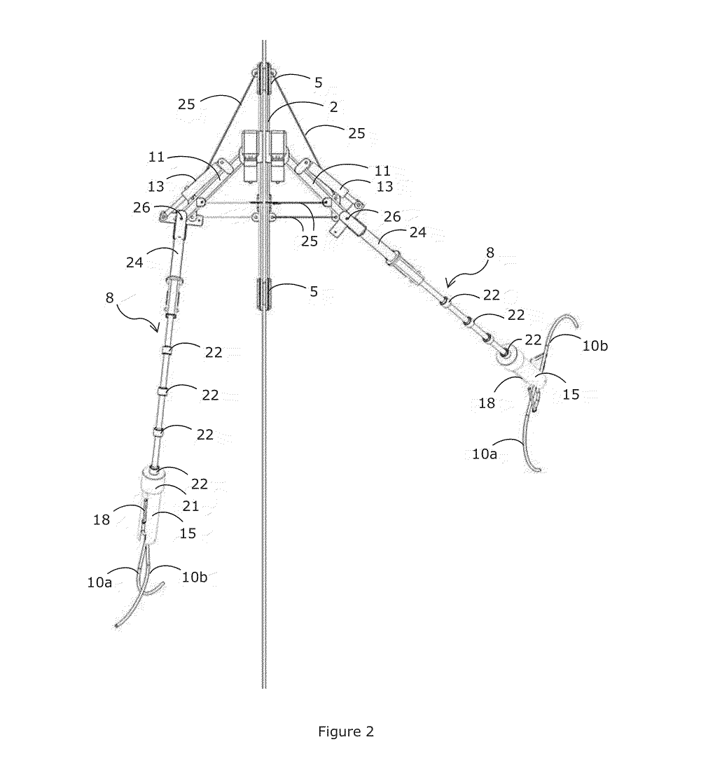

The invention will be described further below by way of example only and with reference to the Figures. One form of the carriage according to the invention is shown in FIGS. 1 to 3. In this form, the carriage 1 comprises a body 2 of any suitable shape having a first end and a second end. Preferably, the body is an elongate platform, beam, bar, rod, or the like, as can be seen in FIG. 2. The carriage 1 is remote controlled and comprises a control system (not shown) supported by the body 2 and comprises at least one battery (preferably two batteries), and a receiver and transmitter for receiving and transmitting signals to a remote controller. Signals from the remote control activate relays which send electric signals to electromagnetic valves for opening and closing the cylinder of hydraulic rams. The control system is typical of that used in cranes and other logging carriages. The body 2 also supports at least one reservoir for storing hydraulic fluid and one or more pumps for pumping oil from the reservoir to hydraulic rams.

Most existing grapple carriages have one or more motors (usually air-cooled diesel motors) that operate an hydraulic pump. These are heavy motors and contribute significantly to the overall weight of the carriage, and therefore a skyline is needed for their operation. In contrast, preferred forms of the grapple carriage of this invention use small lightweight electric motors in combination with small hydraulic tanks to actuate hydraulic rams for controlling the movement of the grapple arms and the operation of the grapple. The electric motors are typically powered by one or more batteries. The batteries may be recharged while in operation, for example by running a belt off the wheels of the carriage to an alternator connected to the batteries.

A coupler 3 is attached to each end of the body 2 for coupling the logging carriage to a cable, so that the first and second ends of the body 2 substantially align with the cable. Each coupler 3 comprises a pair of coupling arms 4 that extend upwardly from the body 2 to support a grooved wheel 5. Each coupler 3 allows a cable 6 to pass between the inner faces of the coupling arms 4 and to be located within the groove of the wheel 5 so that each wheel 5 is able to roll along the cable 6. The grooves in the wheels 5, and the coupling arms 4 on each side of the cable 6, act to guide the wheels 5 along the cable 6, and to couple and suspend the carriage 1 from the cable 6. In preferred forms of the invention, the cable is a skyline although it may alternatively be a haul back.

The wheels 5 are interchangeable with wheels having different groove sizes. For example, a set of wheels having grooves to accommodate a skyline (typically 1⅜ inch diameter) can be changed for wheels having smaller grooves to accommodate a haul back (typically ⅞ inch diameter).

The carriage 1 comprises at least two moveable articulated arms 8 that extend from the body 2 and are able to be manipulated to reach out to logs that need to be picked up and hauled away. The distal end of each arm 8 is attached to a grapple 9 having a pair of opening and closing jaws 10a, 10b for picking up logs and gripping the logs as they are lifted and hauled away by the carriage 1. Having two grapple arms enables substantially increased reach on either side of the cable, compared with known grapple configurations. For example, the invention allows the grapple arms to reach up to 4 metres or more on either side of the centre line of the cable. This reach has not previously been possible using remotely controlled logging systems, but only when a grapple is manipulated manually at ground level.

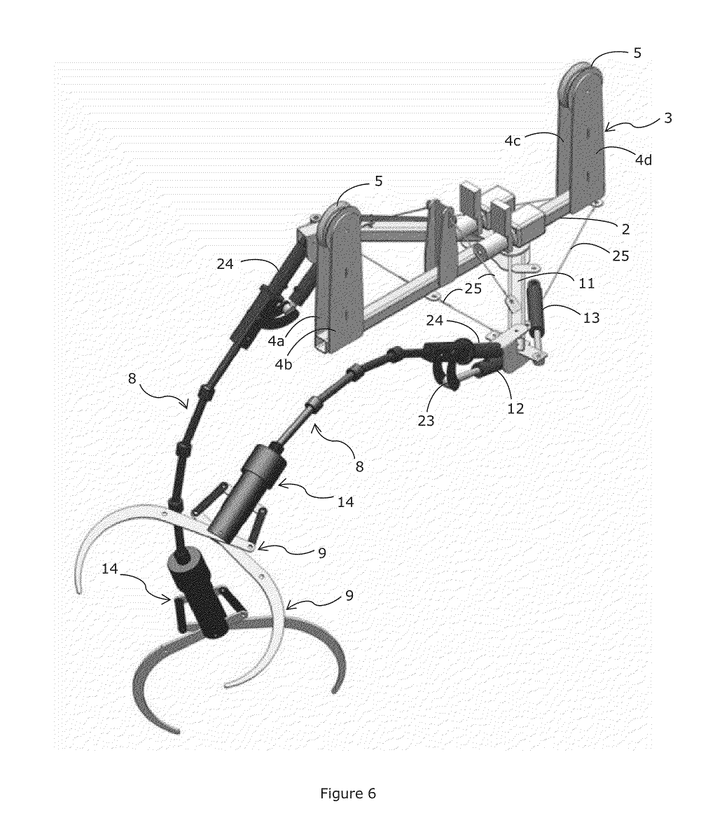

In one form, each arm 8 is attached to the body via a joint 22 that allows the arm 8 to move vertically and/or horizontally in relation to the body 2. For example, each arm may be attached to the body via a universal joint, a pair of pivot joints or a ball joint. In another form, as shown in FIGS. 2 and 6, each arm 8 is attached to the body 2 via a boom 11 that extends substantially horizontally from each side of the body 2. In one form, each boom 11 is attached to the body 2 via a pivot joint so that each boom 11 can extend toward the first or second ends of the body at different angles to the body 2. In another form, each boom 11 may be in a fixed position relative to the body 2. When each boom 11 is in a fixed position, each boom 11 may extend from the body 2 at an angle of between 0° and 180°, for example 90°. In the embodiment shown in FIG. 2, each boom 11 extends from the body 2 at an angle of approximately 45°. Each boom 11 may be supported by one or more tension cables 25 that connect between the booms 11 and the body 2, as shown in FIGS. 2 and 6.

The booms 11 act to increase the sideways reach of the carriage 2 and help to stabilise the arms 8. For a carriage without booms to achieve the same reach as a carriage with booms, the arms of the boomless carriage would need to be longer. This creates a disadvantage because the longer the arms, the more difficult they are to manoeuvre.

In a preferred form, as shown in FIG. 2, each arm 8 is attached to a boom 11 in a way that allows the arm 8 to move both vertically and horizontally in relation to the boom 11. For example, each arm may be attached to the boom via a universal joint or the like. As shown in FIG. 1, each arm 8 comprises a plurality of segments 8a, 8b, 8c, and 8d which are connected together in series, where one end of a segment is connected to a first end of an adjacent segment having a second end connected to the first end of another adjacent segment and so on. The segments are connected together by a plurality of joints 22, which may be universal joints or ball joints for example.

An arm drive section 24 of each arm 8 comprises an hydraulic ram 12, a curved lever 23 and a first segment 8a. In one form, the arm drive section 24 is attached to the distal end of a boom 11 via a universal joint 26 and to a first end of a second segment 8b via a ball joint 22 that connects the first and second segments 8a, 8b. A second end of the second segment 8b attaches to a first end of a third segment 8c, and so on until the last segment (segment 8d in the embodiment of FIG. 1) attaches to the grapple 9. As will be appreciated, it is envisaged that the arm 8 may be formed from any suitable number of arm segments. The segmented structure of each arm enables the strength of each arm to be maintained while supporting the weight of the grapple (and logs).

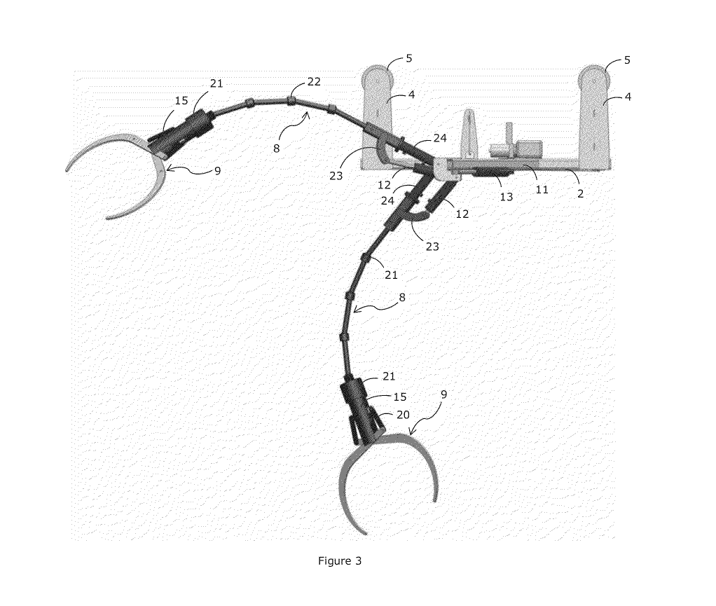

A vertical movement actuator comprising an hydraulic ram 12 is attached to each boom 11 and respective arm drive sections 24 and enables each arm drive section 24 (and therefore each arm 8 itself) to move up and down in relation to the boom 11. In a preferred form, as shown best in FIGS. 1 and 3, each hydraulic ram 12 has a first end attached to a boom 11 and a second opposing end attached to an arm drive section 24. It is preferable for the second end of the hydraulic ram 12 to attach to the arm drive section 24 at or near the end of the arm drive section 24 that attaches to the second segment of the arm, to maximise the range of vertical movement of the arm 8 as a result of actuation by the hydraulic ram 12. To further maximise the range of vertical movement of the arm 8, the hydraulic ram 12 is attached to the arm drive section 24 via an angular or curved lever 23. For example, as shown in FIG. 3, one end of the hydraulic ram 12 is attached to one end of a curved lever 23 via a pivot joint. At its other end, the curved lever 23 is attached to the arm drive section 24. In this arrangement, as the piston of the hydraulic ram 12 moves in and out of its cylinder, the arm drive section 24 (and consequently the arm 8) pivots up and down about the universal joint 26 so that the arm 8 moves vertically in relation to the body 2.

To allow the arms 8 to move back and forth horizontally in relation to the body 8, a horizontal movement actuator connects each arm 8 to a boom 11. In a preferred form, as shown best in FIG. 2, the horizontal movement actuator comprises an hydraulic ram 13 having a first end that is attached to a boom 11 and a second end that is attached to a horizontal movement control lever. Each horizontal movement control lever extends laterally from a vertical pinion of a universal joint 26 and is attached to an arm drive section 24 in a fixed position. In this arrangement, as the piston of the hydraulic ram 13 moves in and out of its cylinder, the piston pushes and pulls respectively against the horizontal movement control lever, causing the universal joint 26 and the attached arm 8 to pivot about the vertical pinion of the universal joint 26. In this way, the arm 8 moves back and forth in relation to the body 2.

As described above, each articulated arm 8 comprises a plurality of arm segments 8a, 8b etc. that are rotatably connected together in series via connectors, such as ball joints 22 or the like. The distal end of each arm 8 is attached to a grapple 9. In this arrangement, the arm segments are able to move individually with respect to each other, allowing the arms 8 to curve and flex in both the vertical and horizontal directions so that the grapples 9 can reach logs in a variety of positions and locations near the carriage 1.

The grapples 9 attached to the arms 8 of the carriage 1 each comprise a pair of opposing jaws 10a, 10b that open and close by pivoting toward and away from each other. A grapple actuator causes the grapple jaws 10a, 10b to open and close. The grapple actuator comprises a grapple control member (not shown) and an actuating system 14. The grapple control member is in the form of an hydraulic ram. The hydraulic ram is located within the first arm segment 24 and is positioned so that its piston extends from its cylinder at the second end of the first arm segment.

As mentioned above, a grapple 9 is attached to the distal end of each arm 8 for picking up and holding one or more logs. Each grapple 9 comprises a pair of jaws 10a, 10b that are pivotably attached to the grapple actuating system 14 for opening and closing the jaws 10a, 10b.

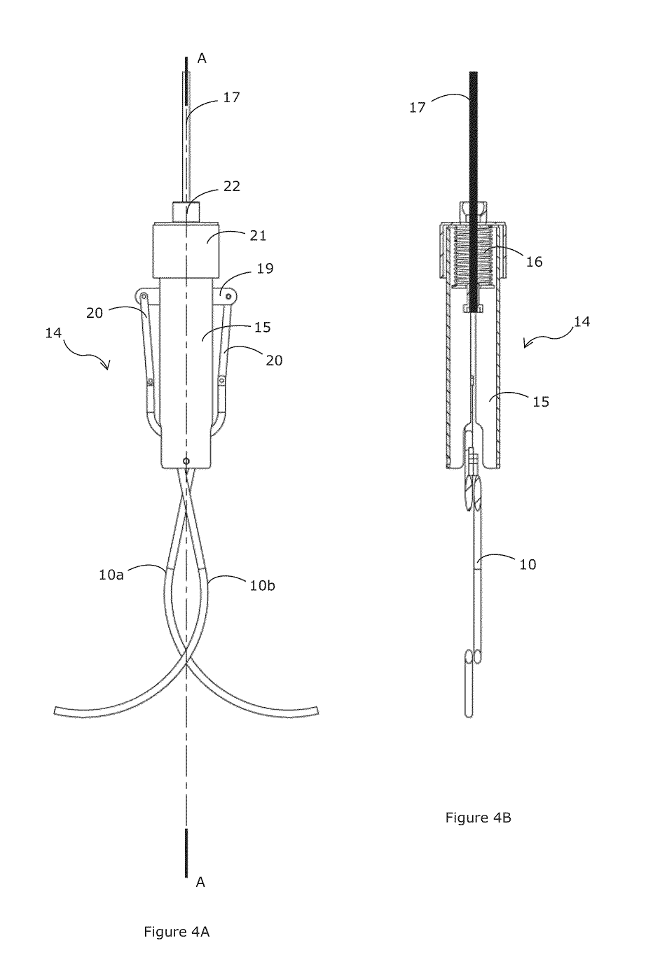

Each grapple actuating system 14 comprises a housing having a first end that attaches to an arm 8 and a second end that attaches to a grapple 9. In one form, as shown in FIGS. 3 and 4A to 5C, the grapple actuating system 14 comprises a floating housing 15 in which the first end of the floating housing 15 is loosely held within a fixed housing 21. In this arrangement, the fixed housing 21 is in the form of a cap having a closed first end that attaches to the distal end of the arm 8 via a ball joint 22 or the like. The second opposing end of the fixed housing 21 comprises an opening in which the floating housing 15 is located. The floating housing 15 is adapted to move back and forth within the fixed housing 21, so that the first end of the floating housing 15 moves toward and away from the first end of the fixed housing 21. Preferably, both the floating housing 15 and the fixed housing 21 are cylindrical.

A biasing means 16, such as a spring, compression member or the like, is held within the floating housing 15 and is biased to an expanded position. The biasing means 16 is adapted to compress against the closed first end of the floating housing 15 and to expand towards the opposing second end of the floating housing 15. A sliding member 19 engages with the biasing means 16 and is adapted to slide back and forth within the floating housing 15. In this arrangement, as the sliding member 19 slides toward the first end of the floating housing 15, the sliding member 19 applies pressure to the biasing means 16 and causes the biasing means 16 to compress against the closed first end of the floating housing 15. As the sliding member 19 moves away from the first end of the floating housing 15, the biasing means 16 expands toward the second end of the floating housing 15.

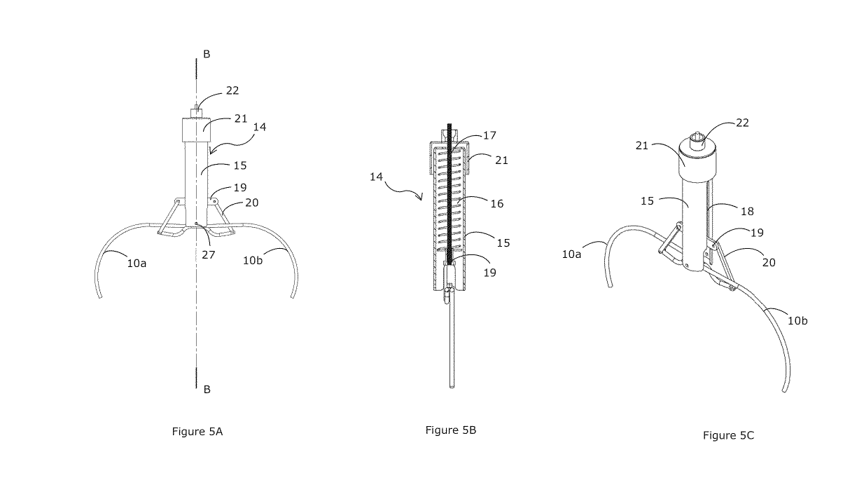

In one form, as shown in FIG. 5C, a slot 18 extends substantially along at least a portion of the length of the floating housing 15 on either side of the floating housing 15. The sliding member 19 comprises a pair of arms, each arm projecting through the slot 18 on either side of the floating housing 15 and each arm being able to move along the slot 18 as the sliding member 19 moves back and forth within the floating housing 15.

Each arm of the sliding member 19 is pivotably attached to a first end of a link 20 that links the grapple jaws 10a, 10b to the sliding member 19. Each link 20 comprises a second opposing end that is pivotably attached to an attachment end of the respective grapple jaw 10a, 10b, as shown in FIGS. 3 and 4A to 5C.

The grapple jaws 10a, 10b are attached together via a pivot joint 27 that connects the jaws 10a, 10b to the floating housing 15 in a pivoting arrangement. The pivot joint 27 is located at or near the second end of the floating housing 15. The grapple jaws 10a, 10b are attached to the pivot joint 27 at a distance from the attachment end of the jaws 10a, 10b so that the jaws 10a, 10b pivot about the pivot joint 27 in a scissor-like arrangement.

A grapple control cable 17 passes through each arm 8 and connects the arm drive section 24 of arm 8 to the grapple actuating system 14 and enables the jaws 10a, 10b of the grapple 9 to be opened and closed. One end of the cable 17 attaches to the piston of the grapple control member. The cable 17 passes through the hollow segments 8a, 8b etc. of each arm 8 and through hollow regions provided within the ball joints 22. The cable 17 then passes through a cable aperture located in the closed first end of the fixed housing 21 and through a cable aperture located in the closed first end of the floating housing 15. Preferably, the cable apertures are centrally located in the closed first ends of the floating housing 15 and the fixed housing 21 so that the apertures substantially align with each other. The cable 17 extends through the floating housing 15 and the biasing means 16 and is attached to the sliding member 19. The grapple control cable 17 is preferably housed within a strong flexible tube, for example hydraulic hosing. This enables the arm to be more controllable. The cable 17 takes the weight of the grapple (when in use holding logs), rather than the arm, which allows the arms to be lightweight and flexible.

The ball joints 22 are rotating joints that allow the grapple 9 to be rotated without the need for a rotate motor and slew ring normally found in traditional grapples. The rotating ball joints 22 also allow the grapple 9 to be presented in position to pick up a log without the need for a grapple hanger.

Previously known grapples and grapple carriages are heavy. The jaws of these grapples are therefore naturally open in an idle state due to their weight. However, the lightweight grapples of the present invention may not be open in an idle state and therefore may require a mechanism to open and close their jaws.

To open the grapple 9, the electronic control system of the carriage 1 receives an appropriate signal via remote control. The electronic control system sends a signal to an hydraulic oil reservoir on the body 2 to pump oil into the hydraulic ram 12 of the arm drive section 24. Actuation of the hydraulic ram 12 causes tension on the grapple control cable 17 to be released, which allows the biasing member 16 to expand within the floating housing 15. As the biasing member 16 expands the sliding member 19 moves away from the first end of the floating housing 15, causing the links 20 to be pushed outwardly and away from the floating housing 15, which in turn pushes the attachment ends of the grapple jaws 10a, 10b outwards to open the grapple.

Conversely, to close the grapple 9, the electronic control system of the carriage 1 receives an appropriate signal via remote control. The electronic control system sends a signal to an hydraulic oil reservoir on the body 2 to draw oil from the hydraulic ram 12. This causes tension to be applied to grapple control cable 17 which, in turn, causes the jaws to move toward each other so that the grapple 9 closes.

The grapple system self-compensates for load by using the floating housing arrangement described above. Thus, the more load on the grapple, the tighter the grapple.

The arms 8 can be moved and manipulated to position the grapple 9 above logs to be picked up and hauled away. Once the logs are held by the grapple 9, the grapple control cable 17 takes the weight of the logs which pulls the grapple jaws 10a, 10b together so that the grapple grips the logs more tightly. The segments 8a, 8b etc. of the arms 8 and the hydraulic rams/controls relax, except for the arm drive section 24. Therefore, as the carriage 1 is pulled along the skyline cable, there is no weight on the hydraulics, except for the arm drive section 24. In some embodiments of the invention, the carriage 1 has a reach of up to four metres or more on either side of the carriage body 2.

The grapple carriage of the invention has several advantages over known carriages. One important advantage is the long reach that the grapples are able to attain either side of the path of the suspended cable (e.g. skyline). This means that a large area either side of the line can be cleared of logs and therefore that the number of times that the line needs to be repositioned is reduced. This leads to faster and more efficient clearing of an area and therefore significant cost savings.

The use of two arms and grapples either side of the suspended line maintains balance during operation.

As will be appreciated, the grapple carriage of the invention may incorporate more than two arms, for example four arms. The booms can be moved backward or forward to allow another set of booms and arms to be added and therefore the carrying capacity of the grapple carriage to be increased from two grapples to four grapples.

The flexibility of the arms that is enabled through the use of multiple arm segments connected through flexible joints means that the grapples are considerably more manoeuvrable than grapples connected to carriage bodies by rigid arms.

Several features of the grapple carriage combine to make it lightweight in comparison with known grapple carriages. The arms are segmented, flexible and rotatable about their joints and are lightweight. This is possible because these components are hollow and accommodate a weight-bearing cable for taking the weight of a loaded grapple. The movement of the carriage and its arms is controlled by small electric motors rather than large heavy diesel motors. The rotational movement in the arms means that heavy rotate motors and slew rings are not needed.

A further advantage is that the grapple carriage is a modular system allowing for the control platform (pumps, radio control, hydraulics) and arms to be fitted onto other platforms.

Although the invention has been described by way of example, it should be appreciated that variations and modifications may be made without departing from the scope of the invention as defined in the claims. Furthermore, where known equivalents exist to specific features, such equivalents are incorporated as if specifically referred in this specification.

Any reference to prior art documents in this specification is not to be considered an admission that such prior art is widely known or forms part of the common general knowledge in the field.

1. A grapple carriage for attaching to a cable suspended above ground and for picking up one or more logs and moving the one or more logs along the path of the cable, the carriage comprising:
a body having a coupler for coupling the body to the cable and enabling the carriage to move along the cable; and
at least two articulated arms extending from the body, each arm having a distal end to which is attached a grapple adapted to pick up, hold and release the one or more logs.

2. A grapple carriage as claimed in claim 1, wherein each arm comprises a vertical movement actuator to control vertical movement of the arm, and a horizontal movement actuator to control horizontal movement of the arm.

3. A grapple carriage as claimed in claim 2, wherein the coupler comprises one or more grooved wheels adapted to movably engage with the cable.

4. A grapple carriage as claimed in any one of claims 1, wherein each arm is pivotably connected to the body via a boom extending from the body.

5. A grapple carriage as claimed in claim 1, wherein each arm is formed from a plurality of arm segments rotatably connected in series.

6. A grapple carriage as claimed in claim 5, wherein each arm comprises 2, 3 or 4 arm segments.

7. A grapple carriage as claimed in claim 5, wherein the segments are connected by ball joints.

8. A grapple carriage as claimed in claim 1, wherein the vertical movement actuator of each arm is located at or near a first end of the arm and proximal to the body and wherein the vertical movement actuator includes an hydraulic ram.

9. A grapple carriage as claimed in claim 1, wherein the horizontal movement actuator of each arm is located at or near a first end of the arm and proximal to the body and wherein the horizontal movement actuator includes an hydraulic ram.

10. A grapple carriage as claimed in claim 1, wherein the distal end of each arm comprises a grapple actuating means for opening and closing jaws of the grapple.

11. A grapple carriage as claimed in claim 10, wherein the grapple actuating means comprises an hydraulic ram.

12. A grapple carriage as claimed in claim 1, further comprising a control system to enable the carriage to be controlled remotely.

13. A grapple carriage as claimed in claim 12, wherein the control system comprises one or more signal transmitters and receivers.

14. A grapple carriage as claimed in claim 12, wherein movement of each arm and each grapple is controlled by hydraulic rams powered by electric motors that are controlled by the control system.

15. A grapple carriage as claimed in claim 1, wherein each arm is able to extend from the body at a distance of approximately 4 metres.
